(19) United States
(12) Patent Application Publication
(10) Pub. No.: US 2009/0210603 A1
(43) Pub. Date: Aug. 20, 2009

(54) Flash memory circuit with combinational interface

(76) Inventors: Chao-Nan Chen, Taipei City (TW); Po-Hsiang Wang, Hsinchu City (TW); Chun-Ming Lu, Taipei City (TW); Ho-Chieh Chuang, Changhua City (TW); Kuo-Hua Yuan, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 12/128,627

(22) Filed: May 29, 2008

(30) Foreign Application Priority Data
Feb. 19, 2008 (TW) 097105727

(51) Int. Cl. G06F 13/14; G06F 12/00

(52) U.S. Cl. 710/305; 711/103; 711/E12.008

(57) ABSTRACT

A flash memory circuit has both SATA and USB interfaces. When the flash memory circuit is coupled to a computer, the flash memory circuit utilizes the transmitted power from the computer through the USB interface for operating, and communicates with the computer through the faster SATA interface for data accessing of the flash memory.

### BACKGROUND OF THE INVENTION

1. Field of the Invention

The present invention relates to a flash memory circuit with combinational interface, and more particularly, to a flash memory circuit with serial advanced technology attachment (SATA) interface and universal serial bus (USB) interface.

2. Description of the Prior Art

Please refer to FIG. 1. FIG. 1 is a diagram illustrating a conventional flash memory circuit 110 and a conventional flash memory circuit 120. As shown in FIG. 1, the flash memory circuit 110 comprises a flash memory (not shown) and a connector 111 of the USB interface. Thus, the flash memory circuit 110 can be coupled to a corresponding socket 141 of the USB interface of the computer 140 through the connector 111 of the USB interface. In this way, the computer 140 can access data from the flash memory (not shown) through the USB interface. The computer 140 provides power to the flash memory circuit 110 through a power pin 1411 of the socket 141 of the USB interface. Therefore, the flash memory circuit 110 can execute data accessing with the computer 140 and receive power by only coupling to the socket of the USB interface of the computer 140. The flash memory circuit 120 comprises a flash memory (not shown) and a connector 121 of the SATA interface. Thus, the flash memory circuit 120 can be coupled to a corresponding socket 142 of the external SATA (eSATA) interface of the computer 140 through the connector 121 of the SATA interface. In this way, the computer 140 can access data from the flash memory (not shown) through the SATA interface. However, the SATA interface does not provide a pin for providing power so that the flash memory circuit 120 has to couple an external power supply 130 for receiving power. In this way, the flash memory circuit 120 can access data with the computer 140 through the SATA interface.

As described above, the conventional flash memory circuit 140 cannot access data with the computer 140 by only coupling the connector 141 to the socket 142. Instead, an external power supply is needed, which is inconvenience to users.

### SUMMARY OF THE INVENTION

The present invention provides a combinational interface circuit. The combinational interface circuit comprises an SATA physical layer processing device, for processing a received SATA signal; and a USB physical layer, for processing a received USB signal.

The present invention further provides a flash memory circuit with a combinational interface. The flash memory circuit comprises a combinational connector of external serial advanced technology attachment (eSATA) interface and universal serial bus (USB) interface, for coupling to a corresponding combinational socket of eSATA interface and USB interface of a computer, the combinational connector of the eSATA interface and the USB interface comprising an eSATA interface, for receiving an SATA signal transmitted from the computer; and a USB interface, for receiving power transmitted from the computer through a corresponding USB interface of the combinational socket of the eSATA interface and the USB interface when the USB interface of the combinational connector of the eSATA interface and the USB interface is coupled to a corresponding USB interface of the combinational socket of the eSATA interface and the USB interface of the computer; a flash memory, for accessing data; and a flash memory controller, coupled to the combinational connector of the eSATA interface and the USB interface, for controlling the flash memory to access data.

The present invention further provides a flash memory circuit with a combinational interface. The flash memory circuit comprises an SATA controller, for transforming a received SATA signal into a first signal; a processor, coupled to the SATA controller, for receiving the first signal and controlling a direction of the first signal; a flash memory controller, coupled to the processor and the SATA controller, for receiving the first signal processed by the processor and accordingly generating a fourth signal; a flash memory, coupled to the flash memory controller, for accessing data according to the fourth signal; a DC/DC converter, for receiving power and converting the received power into an appropriate voltage to provide to the SATA controller, the processor, the flash memory controller, and the flash memory; and a combinational connector of eSATA interface and USB interface, for coupling to a corresponding combinational socket of eSATA interface and USB interface of a computer, the combinational connector of eSATA interface and USB interface comprising a SATA interface, coupled to the SATA controller, for receiving a SATA signal from the computer; and a USB interface, for receiving power from the computer to provide the received power to the DC/DC converter when the combinational connector of the eSATA interface and the USB interface is coupled to the combinational socket of the eSATA interface and the USB interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating two conventional flash memory circuits.

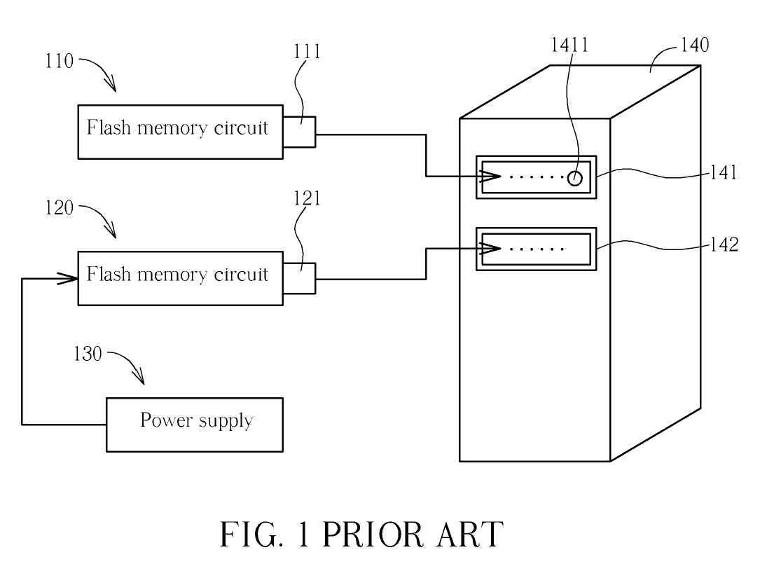

FIG. 2 is a diagram illustrating a flash memory circuit with combinational interface of the present invention.

### DETAILED DESCRIPTION

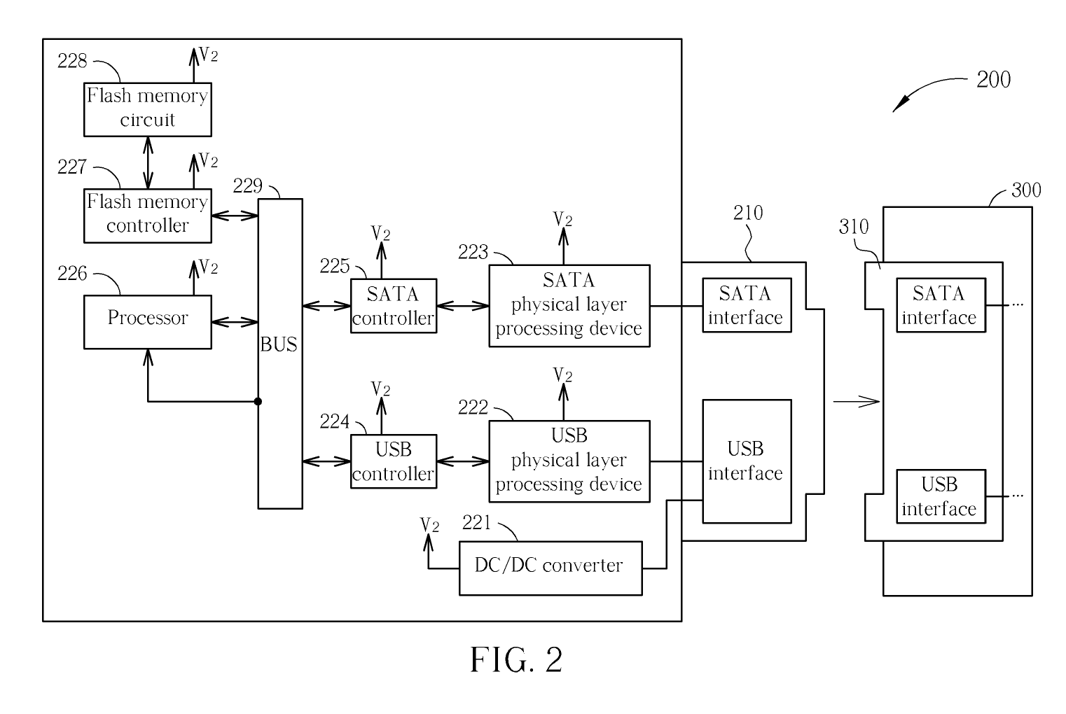

Please refer to FIG. 2. FIG. 2 is a diagram illustrating a flash memory circuit 200 with combinational interface of the present invention. As shown in FIG. 2, the flash memory circuit 200 comprises a combinational connector 210, a DC/DC converter 221, a USB physical layer processing device 222, an SATA physical layer processing device 223, a USB controller 224, an SATA controller 225, a processor 226, a flash memory controller 227, a flash memory 228, and a bus 229. The combinational connector 210 comprises an SATA interface and a USB interface. The combinational connector 210 is disposed for coupling a corresponding combinational socket 310 of the computer 300. The combinational socket 310 similarly comprises an SATA interface and a USB interface. Thus, when the flash memory circuit 200 couples to the combinational socket 310 of the computer 300 through the combinational connector 210, the computer 300 accesses data from the flash memory 228 through the SATA interface or the USB interface.

The DC/DC converter 221 is coupled to the power pin of the USB interface of the combinational connector 210. When the flash memory circuit 200 is coupled to the computer 300, the DC/DC converter 221 receives power transmitted from the computer 300 and converting the received power into an appropriate voltage V₂. Therefore, when the flash memory circuit 200 is coupled to the computer 300, the DC/DC converter 221 outputs a voltage V₂ for providing to the USB physical layer processing device 222, the SATA physical layer processing device 223, the USB controller 224, the SATA controller 225, the processor 226, the flash memory controller 227, and the flash memory 228. The voltage V₂ is adjustable as the components in the flash memory circuit 200 need. In fact, the DC/DC converter 221 can output a plurality of voltages respectively to each component in the flash memory circuit 200. In the present invention, a voltage V₂ is only illustrated as an example and should not be the limitation of the DC/DC converter. Therefore, the flash memory circuit 200 does not have to couple to an external power supply for receiving power.

The SATA physical layer processing device 223 is coupled to the SATA interface of the combinational connector 210 for executing physical layer process of the SATA signals transmitted from the computer 300. After the physical process, the SATA physical layer processing device 223 transmits the processed SATA signals to the SATA controller 225.

The SATA controller 225 is coupled to the SATA physical layer processing device 223 for receiving the processed SATA signals. The SATA controller 225 transforms a received processed SATA signals to a first signal according to the SATA protocol and transmits the first signal to the bus 229.

The USB physical layer processing device 221 is coupled to the USB interface of the combinational connector 210 for executing physical layer process of the USB signals transmitted from the computer 300. After the physical process, the USB physical layer processing device 222 transmits the processed USB signals to the USB controller 224.

The USB controller 224 is coupled to the USB physical layer processing device 221 for receiving the processed USB signals. The USB controller 224 transforms a received processed USB signals to a second signal according to the USB protocol and transmits the second signal to the bus 229.

The processor 226 is coupled to the bus 229. The processor 226 processes data exchanging among the SATA controller 225, the USB controller 224, and the flash memory controller 227 for correctly controlling the flash memory controller 227.

The flash memory controller 227 is coupled to the bus 229. The processor 226 controls the flash memory controller 227 to receive the first signal or the second signal so that the flash memory controller 227 accordingly transmits a third signal to the flash memory 228 for accessing data of the flash memory 228.

Generally, the access speed of the SATA interface is faster than the access speed of the USB interface. Thus, when the processor 226 communicates with the computer 300, the SATA interface has priority over the USB interface. In this way, the data exchanging through the SATA interface between the processor 226 and the computer 300 is faster than the data exchanging through the USB interface. Under the condition that the computer 300 has the combinational socket 310 and also supports the SATA interface, the USB controller 224 and the USB physical layer processing device 222 can be deactivated. However, under the condition that the computer 300 has the combinational socket 310 but only supports the USB interface, the processor 226 has to communicates with the computer 300 through the USB controller 224 and the USB physical layer processing device 222 so that the SATA controller 225 and the SATA physical layer 223 are deactivated, and the USB controller 224 and the USB physical layer 222 have to be activated. More particularly, the processor 226 is notified if the connection of the SATA interface to the computer 300 is established according to the signals transmitted from the SATA physical layer processing device 223. Similarly, the processor 226 is notified if the connection of the USB interface to the computer 300 is established according to the signals transmitted from the USB physical layer processing device 222. When both of the SATA physical layer processing device 223 and the USB physical layer processing device 222 notify the processor 226 that the connection of the SATA interface and the connection of the USB interface are both established, the processor 226 has two choices to communicate with the computer 300. First, the processor 226 receives SATA signals and ignores the USB signals. That is, the processor 226 does not initialize the setting of the USB physical layer processing device 222. Second, the processor 226 receives USB signals and ignores the SATA signals. That is, the processor 226 does not initialize the setting of the SATA physical layer processing device 223. Since the priority of the SATA interface is higher than the priority of the USB interface, the first choice is selected more often. However, the computer 226 still can use one of the both interfaces to communicate with the computer 300 as desired.

To sum up, the flash memory circuit with combinational connector utilizes the power provided by the USB interface and the faster speed of the SATA interface, which increases convenience.

Those skilled in the art will readily observe that numerous modifications and alterations of the device and method may be made while retaining the teachings of the invention.

What is claimed is:

1. A combinational interface circuit, comprising:
an SATA physical layer processing device, for processing a received SATA signal; and
a USB physical layer, for processing a received USB signal.

2. The combinational interface circuit of claim 1, further comprising:
a flash memory controller, coupled to the SATA physical layer processing device and the USB physical layer processing device, for controlling a flash memory to access data; and
a DC/DC converter, for receiving power and converting the received power into an appropriate voltage to provide to the SATA physical layer processing device, the USB physical layer processing device, and the flash memory controller.

3. The combinational interface circuit of claim 2, further comprising:
a combinational connector of eSATA interface and USB interface, for coupling to a corresponding socket of eSATA interface and USB interface of a computer, the combinational connector of the eSATA interface and the USB interface comprising:
an SATA interface, coupled to the SATA physical layer processing device, for receiving a SATA signal transmitted from the computer; and
a USB interface, coupled to the USB physical layer processing device, for receiving power transmitted from the computer through the USB interface when the combinational connector of the eSATA interface and the USB interface is coupled to the combinational socket of the eSATA interface and the USB interface of the computer; and
a flash memory, coupled to the flash memory controller, for accessing data.

4. The combinational interface circuit of claim 3, further comprising:
an SATA controller, coupled to the SATA interface of the combinational connector of the eSATA interface and the USB interface, for transforming a received SATA signal into a first signal;
a USB controller, coupled to the USB interface of the combinational connector of the eSATA interface and the USB interface, for transforming a received USB signal into a second signal; and
a processor, coupled to the SATA controller and the USB controller, for controlling a direction of the first signal and a direction of the second signal.

5. A flash memory circuit with a combinational interface, the flash memory circuit comprising:
a combinational connector of external serial advanced technology attachment (eSATA) interface and universal serial bus (USB) interface, for coupling to a corresponding combinational socket of eSATA interface and USB interface of a computer, the combinational connector of the eSATA interface and the USB interface comprising:
an eSATA interface, for receiving an SATA signal transmitted from the computer; and
a USB interface, for receiving power transmitted from the computer through a corresponding USB interface of the combinational socket of the eSATA interface and the USB interface when the USB interface of the combinational connector of the eSATA interface and the USB interface is coupled to a corresponding USB interface of the combinational socket of the eSATA interface and the USB interface of the computer;
a flash memory, for accessing data; and
a flash memory controller, coupled to the combinational connector of the eSATA interface and the USB interface, for controlling the flash memory to access data.

6. The flash memory circuit of claim 5, further comprising:
a DC/DC converter, coupled to the combinational connector of the eSATA interface and the USB interface, for receiving the power transmitted from the computer and converting the received power into an appropriate voltage to provide to the flash memory controller and the flash memory.

7. The flash memory circuit of claim 6, further comprising:
an SATA controller, coupled to a SATA interface of the combinational connector of the eSATA interface and the USB interface, for transforming a received SATA signal into a first signal; and
a processor, coupled to the SATA controller, for receiving the first signal and accordingly controlling a direction of the first signal.

8. The flash memory circuit of claim 7, further comprising:
an SATA physical layer processing device, coupled between the SATA controller and the SATA interface of the combinational connector of the eSATA interface and the USB interface, for processing a received SATA signal and transmitting the processed received SATA signal to the SATA controller.

9. The flash memory circuit of claim 7, further comprising:
a USB controller, coupled between the processor and the USB interface of the combinational connector of the eSATA interface and the USB interface, for transforming a received USB signal into a second signal;
wherein the processor controls a direction of the first signal and a direction of the second signal respectively.

10. The flash memory circuit of claim 9, further comprising:
a USB physical layer processing device, coupled between the USB interface of the combinational connector of the eSATA interface and the USB interface and the USB controller, for processing a received USB signal and accordingly transmitting the processed received USB signal to the USB controller.

11. A flash memory circuit with a combinational interface, the flash memory circuit comprising:
an SATA controller, for transforming a received SATA signal into a first signal;
a processor, coupled to the SATA controller, for receiving the first signal and controlling a direction of the first signal;
a flash memory controller, coupled to the processor and the SATA controller, for receiving the first signal processed by the processor and accordingly generating a fourth signal;
a flash memory, coupled to the flash memory controller, for accessing data according to the fourth signal;
a DC/DC converter, for receiving power and converting the received power into an appropriate voltage to provide to the SATA controller, the processor, the flash memory controller, and the flash memory; and
a combinational connector of eSATA interface and USB interface, for coupling to a corresponding combinational socket of eSATA interface and USB interface of a computer, the combinational connector of eSATA interface and USB interface comprising:
a SATA interface, coupled to the SATA controller, for receiving a SATA signal from the computer; and
a USB interface, for receiving power from the computer to provide the received power to the DC/DC converter when the combinational connector of the eSATA interface and the USB interface is coupled to the combinational socket of the eSATA interface and the USB interface.

12. The flash memory circuit of claim 11, further comprising:
an SATA physical layer processing device, coupled between the SATA interface of the combinational connector of the eSATA interface and the USB interface and the SATA controller, for processing a received SATA signal and transmitting the processed received SATA signal to the SATA controller.

13. The flash memory circuit of claim 11, further comprising:
a USB controller, coupled between the USB interface of the combinational connector of the eSATA interface and the USB interface and the processor, for transforming a received USB signal into a second signal;
wherein the processor controls a direction of the second signal.

14. The flash memory circuit of claim 13, further comprising:
a USB physical layer processing device, coupled between the USB interface of the combinational connector of the eSATA interface and the USB interface and the USB controller, for processing a received USB signal and transmitting the processed received USB signal to the USB controller.
